(19) United States
(12) Patent Application Publication
(10) Pub. No.: US 2024/0137148 A1
(43) Pub. Date: Apr. 25, 2024

(54) UPDATING A CHANNEL STATE INFORMATION REPORT

(71) Applicant: Lenovo (Singapore) Pte. Ltd., New Tech Park (SG)

(72) Inventors: Ali Ramadan Ali, Kraiburg am Inn (DE); Ankit Bhamri, Rödermark (DE); Ahmed Monier Ibrahim Saleh Hindy, Aurora, IL (US); Vijay Nangia, Woodridge, IL (US)

(21) Appl. No.: 18/548,041

(22) PCT Filed: Feb. 23, 2022
(86) PCT No.: PCT/IB2022/051605

§ 371 Date: Aug. 24, 2023

Related U.S. Application Data
(60) Provisional application No. 63/153,835, filed on Feb. 25, 2021.

(51) Int. Cl. H04L 1/00; H04L 1/1812

(52) U.S. Cl. CPC H04L 1/0026; H04L 1/0028; H04L 1/1812

(57) ABSTRACT

Apparatuses, methods, and systems are disclosed for updating a channel state information report. One method (600) includes receiving (602), at a user equipment, a first configuration from a network device to activate an update of a channel state information (CSI) report. The method (600) includes receiving (604) a second configuration from the network device to perform a resource utilization update on resources from the update of the CSI report. The method (600) includes performing (606) the update of the CSI report. The method (600) includes performing (608) an uplink (UL) transmission based on the resources updated from the resource utilization update. The method (600) includes transmitting (610) an indication to the network device. The indication indicates a type of CSI update and a type of resource utilization update.

### CROSS-REFERENCE TO RELATED APPLICATIONS

This application claims priority to U.S. Patent Application Ser. No. 63/153,835 entitled “APPARATUSES, METHODS, AND SYSTEMS FOR UE-BASED AUTONOMOUS RESOURCE UTILIZATION FOR CSI REPORT UPDATE” and filed on Feb. 25, 2021 for Ali Ramadan Ali et al., which is incorporated herein by reference in its entirety.

### FIELD

The subject matter disclosed herein relates generally to wireless communications and more particularly relates to updating a channel state information report.

### BACKGROUND

In certain wireless communications networks, channel state information reports may be updated too frequently. In such networks, channel state information report updating may be inefficient.

### BRIEF SUMMARY

Methods for updating a channel state information report are disclosed. Apparatuses and systems also perform the functions of the methods. One embodiment of a method includes receiving, at a user equipment, a first configuration from a network device to activate an update of a channel state information (CSI) report. In some embodiments, the method includes receiving a second configuration from the network device to perform a resource utilization update on resources from the update of the CSI report. In certain embodiments, the method includes performing the update of the CSI report. In various embodiments, the method includes performing an uplink (UL) transmission based on the resources updated from the resource utilization update. In some embodiments, the method includes transmitting an indication to the network device. The indication indicates a type of CSI update and a type of resource utilization update.

One apparatus for updating a channel state information report includes a user equipment. In some embodiments, the apparatus includes a receiver that: receives a first configuration from a network device to activate an update of a channel state information (CSI) report; and receives a second configuration from the network device to perform a resource utilization update on resources from the update of the CSI report. In various embodiments, the apparatus includes a processor that: performs the update of the CSI report; and performs an uplink (UL) transmission based on the resources updated from the resource utilization update. In certain embodiments, the apparatus includes a transmitter that transmits an indication to the network device. The indication indicates a type of CSI update and a type of resource utilization update.

Another embodiment of a method for updating a channel state information report includes transmitting, from a network device, a first configuration to a user equipment (UE) to activate an update of a channel state information (CSI) report. In some embodiments, the method includes transmitting a second configuration from the network device to perform a resource utilization update on resources from the update of the CSI report. In certain embodiments, the method includes receiving an indication from the UE. The indication indicates a type of CSI update and a type of resource utilization update.

Another apparatus for updating a channel state information report includes a network device. In some embodiments, the apparatus includes a transmitter that: transmits a first configuration to a user equipment (UE) to activate an update of a channel state information (CSI) report; and transmits a second configuration from the network device to perform a resource utilization update on resources from the update of the CSI report. In various embodiments, the apparatus includes a receiver that receives an indication from the UE. The indication indicates a type of CSI update and a type of resource utilization update.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for updating a channel state information report;

FIG. 2 is a schematic block diagram illustrating one embodiment of an apparatus that may be used for updating a channel state information report;

FIG. 3 is a schematic block diagram illustrating one embodiment of an apparatus that may be used for updating a channel state information report;

FIG. 4 is a schematic grid diagram illustrating one embodiment of UCI over PUSCH RE mapping;

FIG. 5 is a schematic block diagram illustrating one embodiment of a system for gNB decoding of UE-based signaling of a CSI report update and/or utilization type for UCI over PUSCH;

FIG. 6 is a flow chart diagram illustrating one embodiment of a method for updating a channel state information report; and

FIG. 7 is a flow chart diagram illustrating another embodiment of a method for updating a channel state information report.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes to be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

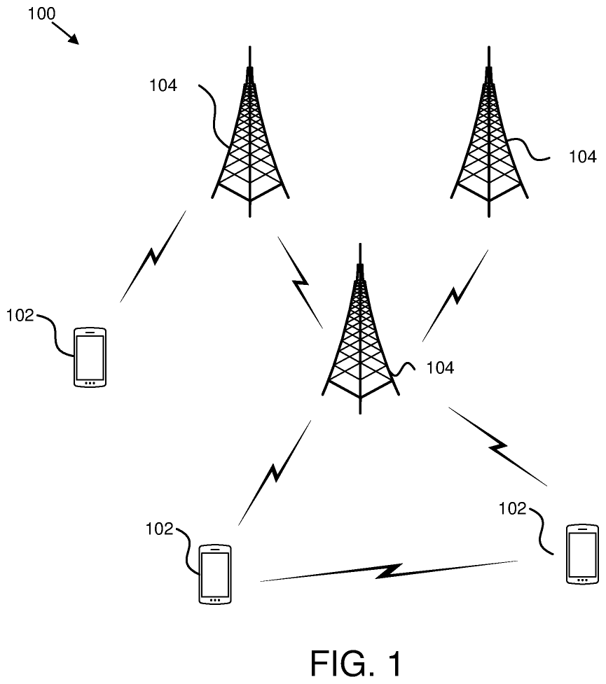

FIG. 1 depicts an embodiment of a wireless communication system 100 for updating a channel state information report. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive, at a user equipment, a first configuration from a network device to activate an update of a channel state information (CSI) report. In some embodiments, the remote unit 102 may receive a second configuration from the network device to perform a resource utilization update on resources from the update of the CSI report. In certain embodiments, the remote unit 102 may perform the update of the CSI report. In various embodiments, the remote unit 102 may perform an uplink (UL) transmission based on the resources updated from the resource utilization update. In some embodiments, the remote unit 102 may transmit an indication to the network device. The indication indicates a type of CSI update and a type of resource utilization update. Accordingly, the remote unit 102 may be used for updating a channel state information report.

In certain embodiments, a network unit 104 may transmit, from a network device, a first configuration to a user equipment (UE) to activate an update of a channel state information (CSI) report. In some embodiments, the network unit 104 may transmit a second configuration from the network device to perform a resource utilization update on resources from the update of the CSI report. In certain embodiments, the network unit 104 may receive an indication from the UE. The indication indicates a type of CSI update and a type of resource utilization update. Accordingly, the network unit 104 may be used for updating a channel state information report.

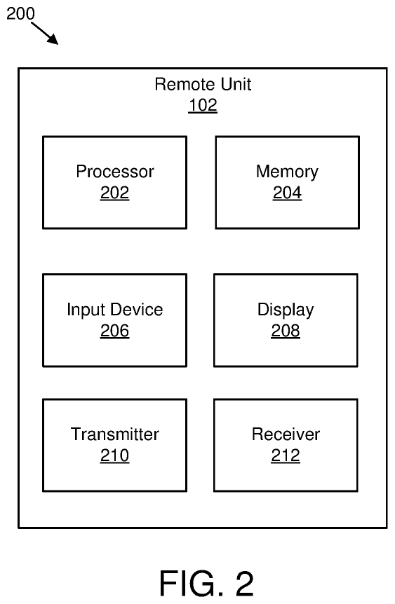

FIG. 2 depicts one embodiment of an apparatus 200 that may be used for updating a channel state information report. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212: receives a first configuration from a network device to activate an update of a channel state information (CSI) report; and receives a second configuration from the network device to perform a resource utilization update on resources from the update of the CSI report. In various embodiments, the processor 202: performs the update of the CSI report; and performs an uplink (UL) transmission based on the resources updated from the resource utilization update. In certain embodiments, the transmitter 210 transmits an indication to the network device. The indication indicates a type of CSI update and a type of resource utilization update.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

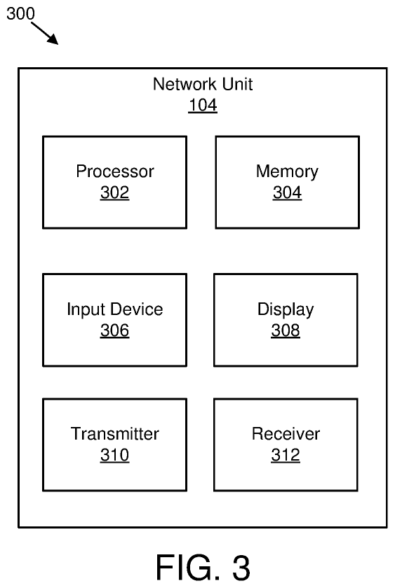

FIG. 3 depicts one embodiment of an apparatus 300 that may be used for updating a channel state information report. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively. In certain embodiments, the transmitter 310: transmits a first configuration to a user equipment (UE) to activate an update of a channel state information (CSI) report; and transmits a second configuration from the network device to perform a resource utilization update on resources from the update of the CSI report. In various embodiments, the receiver 312 receives an indication from the UE. The indication indicates a type of CSI update and a type of resource utilization update.

In certain embodiments, such as for a channel state information (“CSI”) report in new radio (“NR”), a user equipment (“UE”) may be configured via radio resource control (“RRC”), medium access control (“MAC”) control element (“CE”), and/or downlink control information (“DCI”) to report CSI quantities based on measurement of a CSI reference signal (“RS”) (“CSI-RS”) on some configured resources and reports the measurements quantities over a physical uplink control channel (“PUCCH”) or physical uplink shared channel (“PUSCH”) if available. For example, the configuration of a semi-persistent CSI report over PUSCH may be signaled via RRC and, hence, the UE is requested to report the CSI over a predefined period of time. The activation and/or deactivation of the semi-persistent CSI report may be signaled to the UE using DCI. The activation or the deactivation of the CSI report may be decided by a network and may be based on different conditions (e.g., scheduling and UL grant requirements, reliability and/or latency requirements, previous reports, and so forth). In some embodiments, such as if a UE has low mobility, CSI quantities don't change much between different CSI report occasions. However, in such embodiments, the UE keeps sending this information until it receives a reconfiguration or deactivation from a gNB. To allow fast reconfiguration of a CSI report if a channel is static or semi-static, a UE may skip or omit some CSI quantities. In various embodiments, a UE may be enabled to perform efficient resource utilization after applying a CSI update or omission based on predefined rules from a network.

In some embodiments, procedures and/or signaling enhancement at a UE may be used to perform: 1) utilization of configured and unused resource elements (“REs”) gained from a CSI report update and/or reduction based on a configured set of rules and/or methods (e.g., using resources for enhancement of the transmission of the rest of CSI quantities over PUSCH or PUCCH and/or other reported uplink control information (“UCI”) quantities); 2) utilization of the configured and unused REs gained from a CSI report dropping, cancelling, and/or omitting based on a configured set of rules and/or methods for PUSCH transmission with a reduced modulation and coding scheme (“MCS”) (e.g., additional redundancy and/or channel-coded bits for the scheduled, configured, and/or indicated transport block on PUSCH) and/or PUSCH repetition (e.g., if UCI multiplexing with PUSCH is configured); and/or 3) implicit indication from a UE to a gNB of the changes it has performed on a configured report using a demodulation reference signal (“DMRS”) sequence of PUSCH and/or PUCCH or a combination of DMRS, and/or explicit indication on dedicated REs of PUSCH. These REs may use a modulation and/or coding scheme different than that used for a CSI part 1.

In various embodiments, a CSI report update and/or reduction or CSI report dropping, cancellation, and/or omission may correspond to at least a CSI having a fixed payload size (e.g., CSI report including a fixed CSI payload size; CSI report including two parts—CSI part 1 which is a fixed payload size and CSI part 2 which is a variable payload size whose size is indicated in CSI part 1).

In certain embodiments, a UE may apply enhancements to the rest of a CSI report and other UL transmissions by using the unused REs resulting from a CSI report update which optimizes the resource utilization of UL transmissions without dynamic configuration (e.g., or reconfiguration) from a base station.

In a first embodiment, there may be network signaling of a type of RE utilization for an updated CSI report. According to the first embodiment, a UE receives a configuration from a base station to apply resource utilization on REs gained from a CSI report omission and/or reduction based on pre-defined conditions. The network indicates to the UE via higher-layer signaling (e.g., RRC) or DCI allowed resource utilization types which the UE can perform on the configured and unused REs after a UE-based CSI report change with indices of the possible utilization types (e.g., the UE can indicate the index of the resource utilization in control signaling (e.g., non-data-associated control signaling) on PUSCH). Furthermore, the UE may be indicated with a flag in a CSI report set configuration or in DCI to indicate whether the UE-based resource utilization is on or off. If the UE doesn't receive this flag, it assumes that no update or change on the configured resources of the CSI report is allowed. The UE uses the configuration to perform possible utilization of the remaining REs for enhancing other UL transmissions. In one implementation, the gNB explicitly sends via RRC a type of utilization the UE can use if the number of REs can satisfy the specific utilization type. In another implementation, the type of resource utilization is based on a predefined table as illustrated in Table 1.

In some embodiments, a UE indicates one index from a configured table in a CSI report to inform a gNB about which method (e.g., procedure) of resource utilization is to be applied.

TABLE 1
Example of indication of type of RE configuration.

| Index | Method of Resource Utilization |
|---|---|
| 0 | Changing of PUSCH MCS value to the next lower value (e.g., |
| | additional redundancy and/or channel-coded bits for the |
| | scheduled, configured, and/or indicated transport block |
| | on PUSCH) |
| 1 | Increasing RE repetition of ACK/NACK/RI |
| 2 | Increasing bit repetition code for ACK/NACK/RI |
| 3 | Changing wideband CQI to sub-band CQI |
| 4 | REs not utilized |
| 5 | Updating the beta offset for the reported quantities (e.g., |
| | to improve the reliability) |
| 6 | An additional Group of CSI Report bit sequence is appended to |
| | CSI Report Part 2 with k Groups, if applicable, where |
| | k = 0, 1, 2 . . . |
| 7 | Updating number of repetitions for PUSCH (e.g., increasing a |
| | number of repetitions if enough resources are released because |
| | of CSI update, reduction, and/or omission) |

In a second embodiment, there may be a UE procedure for using remaining REs. According to the second embodiment, upon receiving an activation flag from the network and configuration regarding possible utilization types, the UE performs a suitable utilization method for the remaining REs that result from a CSI omission and/or reduction. A gNB may further configure the UE with pre-defined rules for mapping the REs of the rest of CSI report after a CSI report change.

In various embodiments, based on a number of remaining REs, an UE may enhance a PUSCH transmission, for uplink control information (“UCI”) multiplexing with PUSCH, by applying a lower MCS (e.g., additional redundancy and/or channel-coded bits for the scheduled, configured, and/or indicated transport block on PUSCH) to allow for mapping over the empty REs. In certain embodiments, a UE may increase RE repetition of acknowledgement (“ACK”), negative ACK (“NACK”), and/or rank indicator (“RI”) or increase a bit level repetition code length to enhance ACK, NACK, and/or RI transmission. In some embodiments, a UE may change the resolution of one or more CSI quantities (e.g., changing wideband channel quality indicator (“CQI”) and/or wideband precoding matrix indication (“PMI”)) to a sub-band report to fill remaining REs if the UE performed the sub-band measurements and found that the difference between the current and the previous measurement for these quantities is larger than a certain threshold. In various embodiments, a UE may enhance a PUSCH transmission by updating a number of repetitions for PUSCH (e.g., increasing a number of repetitions if enough resources are released because of a CSI update, reduction, and/or omission).

In certain embodiments, if a measured CQI is below a certain threshold, then a UE may drop and/or update a CSI report and autonomously update a MCS of a current PUSCH according to the measured CQI by using the resources from UCI on PUSCH. The MCS used for transmission of the PUSCH may be indicated from the UE to a base station based on the methods and/or procedures described in a third embodiment found herein.

In some embodiments, for a periodic or semi-persistent CSI report over PUCCH, a UE is configured with different utilization types in a PUCCH resource set configuration to update PUCCH transmission parameters upon calculating a number of REs gained from CSI report reduction. In various embodiments, a UE updates a coding type for transmitting CSI data. For example, if the original size of the CSI information to be transmitted using PUCCH format 3 is more than 11 bits and after the CSI report reduction it becomes less than 11 bits, the UE may change the configured coding scheme from Polar to Reed-Muller or to a simplex code. The UE may update the modulation scheme from quadrature phase shift keying (“QPSK”) to Pi/2 binary phase shift keying (“BPSK”) (“Pi/2-BPSK”) to enhance a cubic metric (“CM”) of a PUCCH transmission. In certain embodiments, a UE may apply RE and/or RB repetition on the rest of a CSI report or repetition of ACK and/or NACK. In some embodiments, if a CSI report is extremely reduced, a UE may override a configured PUCCH format and change the PUCCH format (e.g., from PUCCH format 3 to PUCCH format 2 if the reduced CSI report can be sent in 1 or two symbols).

In various embodiments, a CSI report may be partitioned into a set of one or more parts, wherein each part in a subset of the set of one or more parts is further partitioned into one or more groups, if applicable, wherein one or more groups in a CSI report are reported across the remaining REs. In one example, a CSI report is partitioned into two parts, wherein the second part is further partitioned into four groups (e.g., Group 0, 1, 2, 3), and wherein Group 3 of Part 2 in the CSI report is reported across the remaining REs, and is reported in case of omission. For instance, Group 3 may include additional coefficient information, an indication of non-zero coefficients, and/or additional layer information for PMI reported in the CSI report.

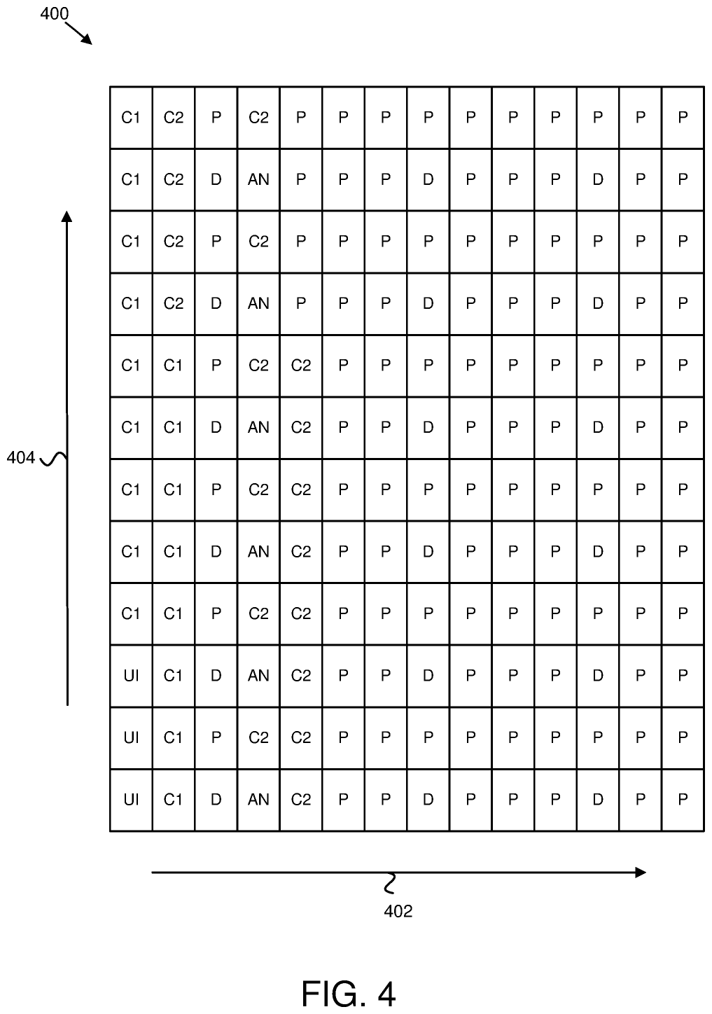

In a third embodiment, there may be signaling of a CSI report update and resource utilization information. According to the third embodiment, a UE indicates changes it has performed on a report and/or REs utilization types it has chosen using a DMRS sequence of PUSCH and/or PUCCH or a combination of DMRS and signaling on dedicated REs. FIG. 4 shows an example of UCI over PUSCH reported by UE with indications of CSI report update and/or reduction and/or the REs utilization type on dedicated REs (e.g., pre-defined RE mapping on PUSCH; the number of REs may be based on the MCS of the PUSCH data).

FIG. 4 is a schematic grid diagram illustrating one embodiment of UCI 400 over PUSCH RE mapping. The UCI 400 is illustrated over an orthogonal frequency division multiplexing (“OFDM”) symbols 402, and subcarriers 404. The UCI 400 includes a CSI part 1 (“C1”), a CSI part 2 (“C2”), a UE identification (“UI”) (e.g., identification of the update type and/or utilization, may use an MCS different than CSI part 1), PUSCH data (“P”), DMRS (“D”), and ACK and/or NACK (“AN”).

In certain embodiments, a UE indicates a change of a CSI report by signaling an index of a pre-defined table of different CSI updates as shown in Table 2 and/or the type of utilization using the pre-defined Table 1. The Tables 1 and 2 may be predefined or shared with a UE as part of a CSI report setting configuration (e.g., via RRC).

TABLE 2
Example of UE indication of CSI report update.

| Index | The Performed CSI updates |
|---|---|
| 0 | No change |
| 1 | ‘cri-RI-PMI-CQI’ ---- > ‘cri-RI-CQI’ |
| 2 | ‘cri-RI-PMI-CQI’ ---- > ‘cri-RI’ |
| 3 | ‘cri-RI-CQI’ --- > ‘cri-RI’ |
| 4 | ‘cri-RI-PMI-CQI’ ---- > ‘cri-RI’ |
| 5 | Sub-band CQI ---- > wide band CQI |
| 6 | No CSI report is fed back |
| 7 | 2 PMI → 1 PMI per CSI Report, if |
| | applicable |

In Table 2 Index 7, a UE configured with feeding back 2 PMI quantities under multiple transmission and reception point (“TRP”) (“multi-TRP”) CSI reporting corresponding to two channel measurement hypotheses may indicate to the network that it would report 1 PMI only. This option may be applicable (e.g., but not necessarily limited to) multi-TRP transmission.

In certain embodiments, a UE doesn't explicitly send a type of utilization to a gNB and it signals only a number of gained REs from a CSI reduction stage. Based on pre-defined rules, the type of the resource utilization is associated with the number of the REs and the gNB assumes the type of RE utilization based on different values of the signaled number of REs. An example is illustrated in Table 3. The example in Table 3 may be different based on PUSCH configurations for UCI over PUSCH, which includes the configured MCS of PUSCH, resource block (“RB”) allocations, DMRS additional symbols, and so forth. The same may apply for PUCCH, for which a number of symbols, a number of RBs, a PUCCH format, and so forth need to be taken into account if the association between the gained REs and the utilization type is used.

TABLE 3
An example of association between # gained REs from
CSI reduction and/or omission and the utilization type

| Number of REs | Type of Resource Utilization |
|---|---|
| <10 REs | No change. CSI report uses the same parameters |
| 10 < REs < 100 | Enhancement of ACK/NACK repetition |
| >100 | MCS update (a one step down value or additional |
| | redundancy and/or channel-coded bits for the |
| | scheduled, configured, and/or indicated transport |
| | block on PUSCH) |

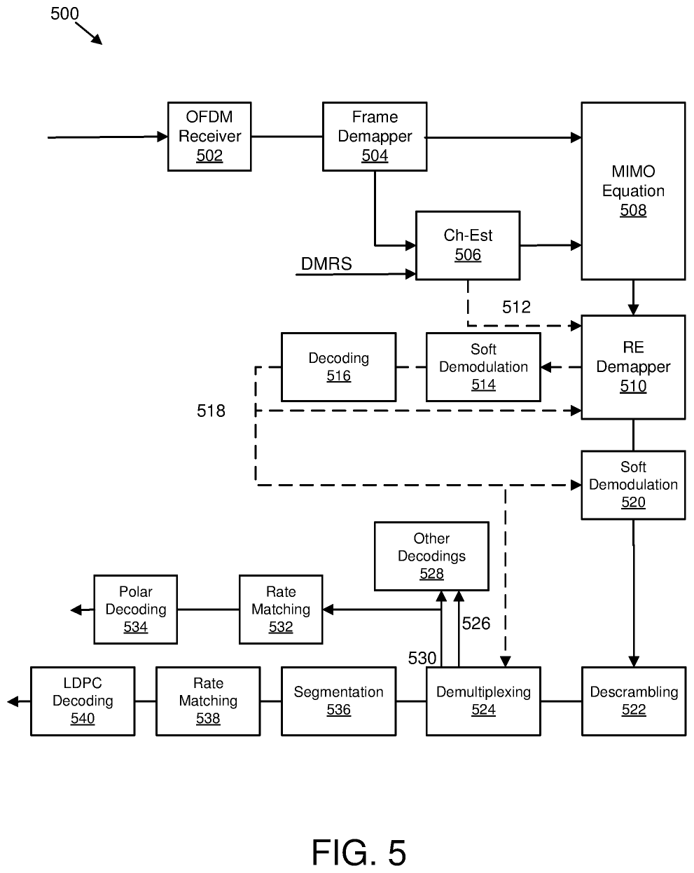

In some embodiments, a UE receives from a network a configuration for a signal to be used for indicating a type of CSI update and a type of resource utilization. In one implementation, the UE may be indicated to use DMRS sequence for signaling the information of the updates and the utilization type it has performed on the CSI report. The gNB configures the UE with multiple sequences that the UE can use. The UE applies an association between the utilization type it has used and selects a corresponding DMRS sequence. During channel estimation, the gNB tries with different DMRS sequences and decodes the information of the UE-based update of the CSI report and the type of RE utilization. In another implementation, the indications of the CSI update and the type of utilization are sent as a combination on both DMRS and explicit information mapped to dedicated REs. In one example, part of the information (e.g., the position and/or offset of the REs used for signaling the CSI update and/or the utilization type) is sent using a DMRS sequence while the detailed information is sent on dedicated REs used for this purpose. In another example, a least significant bit (“LSB”) of a combination of both indications are sent on DMRS and the rest of bits are sent on the dedicated REs. FIG. 5 shows a block diagram of a PUSCH receiver including decoding of a UE indication and/or signaling used for signaling the type of the change it has made on a CSI report and/or a type of RE utilization. In FIG. 5, a DMRS sequence is used for indication or used as a first stage of UE indication to signal part of the UE indication information, or for indicating the location of the REs used for signaling the type of CSI change and/or the type of RE utilization. Detailed information of a UE indication may be sent on dedicated REs demodulated and decoded based on a pre-defined scheme. The decoded information may be used for further de-mapping of the rest of the UCI information and/or for demultiplexing of data and the different UCI quantities in a bit level after de-scrambling and/or deinterleaving.

Specifically, FIG. 5 is a schematic block diagram illustrating one embodiment of a system 500 for gNB decoding of UE-based signaling of a CSI report update and/or utilization type for UCI over PUSCH. The system 500 includes an OFDM receiver 502 receiving an input signal then providing an output to a frame demapper 504. The frame demapper 504 provides output to a channel estimator 506 (Ch-Est). The channel estimator 506 also receives DMRS and provides an output to a multiple-input multiple output (“MIMO”) equation 508. The MIMO equation 508 also receives output from the frame demapper 504. The MIMO equation 508 provides an output to a RE demapper 510. Further, the channel estimator 506 may provide a DMRS-based UE indication 512 (e.g., the UE indication indicating REs location) to the RE demapper 510.

The RE demapper 510 may provide an output to a soft demodulation 514 which provides an output to a decoding 516. The decoding 516 output a UE indication 518 to the RE demapper 510 and a soft demodulation 520. The RE demapper 510 also provides an output to the soft demodulation 520. The soft demodulation 520 provides an output to descrambling 522 which provides an output to demultiplexing 524 (which also receives the UE indication 518). The demultiplexing 524 outputs ACK and/or NACK 526 to other decodings 528, and the demultiplexing 524 outputs CSI 530 to the other decodings 528 if less than 11 bits and rate matching 532 if greater than 11 bits. The rate matching 532 provides an output to polar decoding 534. Further, the demultiplexing 524 provides an output to segmentation 536 which provides an output to rate matching 538 which provides an output to low-density parity-check (“LDPC”) decoding 540.

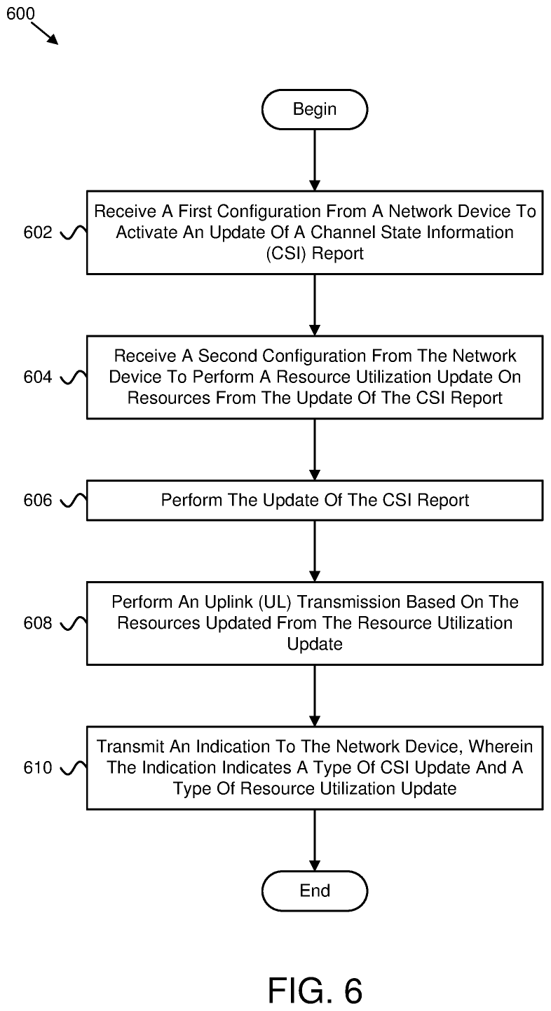

FIG. 6 is a flow chart diagram illustrating one embodiment of a method 600 for updating a channel state information report. In some embodiments, the method 600 is performed by an apparatus, such as the remote unit 102. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes receiving 602, at a user equipment, a first configuration from a network device to activate an update of a channel state information (CSI) report. In some embodiments, the method 600 includes receiving 604 a second configuration from the network device to perform a resource utilization update on resources from the update of the CSI report. In certain embodiments, the method 600 includes performing 606 the update of the CSI report. In various embodiments, the method 600 includes performing 608 an uplink (UL) transmission based on the resources updated from the resource utilization update. In some embodiments, the method 600 includes transmitting 610 an indication to the network device. The indication indicates a type of CSI update and a type of resource utilization update.

In certain embodiments, the method 600 further comprises receiving, via radio resource control (RRC) signaling, a CSI report set configuration or a flag activating or deactivating of a resource element (RE) utilization procedure. In some embodiments, the method 600 further comprises performing the update of the CSI report, a RE utilization procedure, or a combination thereof based on a table. In various embodiments, the method 600 further comprises receiving, via RRC signaling from the network device, information indicating an updated mapping table, wherein the update of the CSI report, a RE utilization procedure, or a combination thereof is performed based on the updated mapping table.

In one embodiment, the method 600 further comprises applying a utilization method of remaining REs that result from the update of the CSI report. In certain embodiments, the method 600 further comprises using a lower modulation and coding scheme (MCS) value for physical uplink shared channel (PUSCH) transmission based on a number of the remaining REs. In some embodiments, the method 600 further comprises applying RE repetition, modifying a repetition code for hybrid automatic repeat request (HARQ) feedback, modifying a rank indication (RI), or some combination thereof.

In various embodiments, the method 600 further comprises modifying a coding type of a physical uplink control channel (PUCCH) transmission in response to a number of bits being reduced from greater than or equal to 11 bits to less than 11 bits or modifying a modulation type from quadrature phase shift keying to Pi/2 binary phase shift keying. In one embodiment, the method 600 further comprises using a higher granularity of CSI quantities that have been changed from a last report based on a predefined threshold value. In certain embodiments, the method 600 further comprises reporting a sub-band CQI in place of a configured wide-band CQI.

In some embodiments, the method 600 further comprises indicating to the network unit a procedure used for a CSI report reduction and a type of RE utilization. In various embodiments, a demodulation reference signal (DMRS) is used for carrying signaling to the network unit.

In one embodiment, indication information is mapped to dedicated REs with a pre-defined modulation and coding scheme on pre-defined locations in a resource block (RB) based on a remote unit configuration or with an arbitrary location decided by the UE. In certain embodiments, the method 600 further comprises using DMRS and an explicit indication corresponding to REs to indicate a selected CSI reduction procedure, a RE utilization procedure, or a combination thereof.

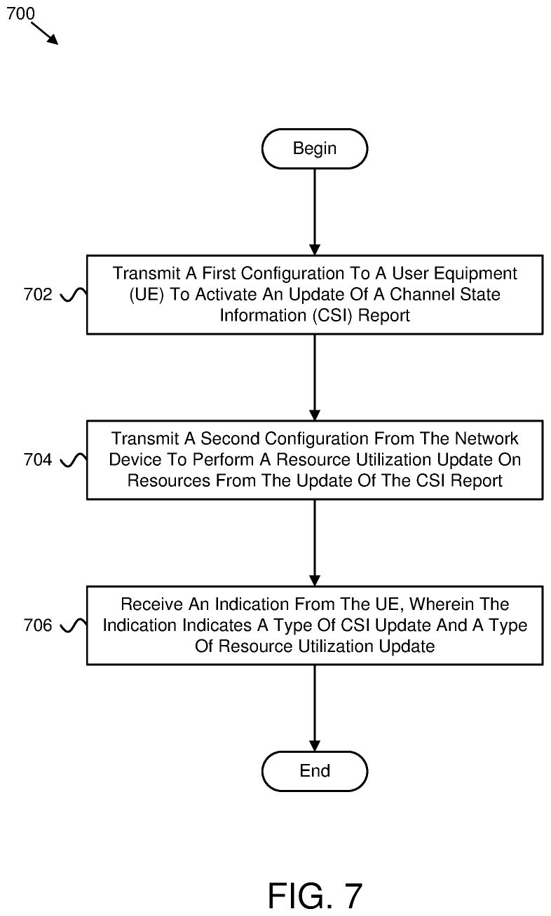

FIG. 7 is a flow chart diagram illustrating one embodiment of a method 700 for updating a channel state information report. In some embodiments, the method 700 is performed by an apparatus, such as the network unit 104. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes transmitting 702, from a network device, a first configuration to a user equipment (UE) to activate an update of a channel state information (CSI) report. In some embodiments, the method 700 includes transmitting 704 a second configuration from the network device to perform a resource utilization update on resources from the update of the CSI report. In certain embodiments, the method 700 includes receiving 706 an indication from the UE. The indication indicates a type of CSI update and a type of resource utilization update.

In certain embodiments, the method 700 further comprises transmitting, via radio resource control (RRC) signaling, a CSI report set configuration or a flag activating or deactivating of a resource element (RE) utilization procedure. In some embodiments, the method 700 further comprises transmitting, via RRC signaling from the network device, information indicated an updated mapping table, wherein the update of the CSI report, a RE utilization procedure, or a combination thereof is performed based on the updated mapping table.

In various embodiments, the method 700 further comprises receiving an indication indicating a procedure used for a CSI report reduction and a type of RE utilization. In one embodiment, a demodulation reference signal (DMRS) is used for carrying signaling for the UE.

In one embodiment, an apparatus comprises a user equipment (UE). The apparatus further comprises: a receiver that: receives a first configuration from a network device to activate an update of a channel state information (CSI) report; and receives a second configuration from the network device to perform a resource utilization update on resources from the update of the CSI report; a processor that: performs the update of the CSI report; and performs an uplink (UL) transmission based on the resources updated from the resource utilization update; and a transmitter that transmits an indication to the network device, wherein the indication indicates a type of CSI update and a type of resource utilization update.

In certain embodiments, the receiver receives, via radio resource control (RRC) signaling, a CSI report set configuration or a flag activating or deactivating of a resource element (RE) utilization procedure.

In some embodiments, the processor performs the update of the CSI report, a RE utilization procedure, or a combination thereof based on a table.

In various embodiments, the receiver receives, via RRC signaling from the network device, information indicating an updated mapping table, wherein the update of the CSI report, a RE utilization procedure, or a combination thereof is performed based on the updated mapping table.

In one embodiment, the processor applies a utilization method of remaining REs that result from the update of the CSI report.

In certain embodiments, the processor uses a lower modulation and coding scheme (MCS) value for physical uplink shared channel (PUSCH) transmission based on a number of the remaining REs.

In some embodiments, the processor applies RE repetition, modifying a repetition code for hybrid automatic repeat request (HARQ) feedback, modifying a rank indication (RI), or some combination thereof.

In various embodiments, the processor modifies a coding type of a physical uplink control channel (PUCCH) transmission in response to a number of bits being reduced from greater than or equal to 11 bits to less than 11 bits or modifying a modulation type from quadrature phase shift keying to Pi/2 binary phase shift keying.

In one embodiment, the processor uses a higher granularity of CSI quantities that have been changed from a last report based on a predefined threshold value.

In certain embodiments, the processor reports a sub-band CQI in place of a configured wide-band CQI.

In some embodiments, the processor indicates to the network unit a procedure used for a CSI report reduction and a type of RE utilization.

In various embodiments, a demodulation reference signal (DMRS) is used for carrying signaling to the network unit.

In one embodiment, indication information is mapped to dedicated REs with a pre-defined modulation and coding scheme on pre-defined locations in a resource block (RB) based on a remote unit configuration or with an arbitrary location decided by the UE.

In certain embodiments, the processor uses DMRS and an explicit indication corresponding to REs to indicate a selected CSI reduction procedure, a RE utilization procedure, or a combination thereof.

In one embodiment, a method of a user equipment (UE) comprises: receiving a first configuration from a network device to activate an update of a channel state information (CSI) report; receiving a second configuration from the network device to perform a resource utilization update on resources from the update of the CSI report; performing the update of the CSI report; performing an uplink (UL) transmission based on the resources updated from the resource utilization update; and transmitting an indication to the network device, wherein the indication indicates a type of CSI update and a type of resource utilization update.

In certain embodiments, the method further comprises receiving, via radio resource control (RRC) signaling, a CSI report set configuration or a flag activating or deactivating of a resource element (RE) utilization procedure.

In some embodiments, the method further comprises performing the update of the CSI report, a RE utilization procedure, or a combination thereof based on a table.

In various embodiments, the method further comprises receiving, via RRC signaling from the network device, information indicating an updated mapping table, wherein the update of the CSI report, a RE utilization procedure, or a combination thereof is performed based on the updated mapping table.

In one embodiment, the method further comprises applying a utilization method of remaining REs that result from the update of the CSI report.

In certain embodiments, the method further comprises using a lower modulation and coding scheme (MCS) value for physical uplink shared channel (PUSCH) transmission based on a number of the remaining REs.

In some embodiments, the method further comprises applying RE repetition, modifying a repetition code for hybrid automatic repeat request (HARQ) feedback, modifying a rank indication (RI), or some combination thereof.

In various embodiments, the method further comprises modifying a coding type of a physical uplink control channel (PUCCH) transmission in response to a number of bits being reduced from greater than or equal to 11 bits to less than 11 bits or modifying a modulation type from quadrature phase shift keying to Pi/2 binary phase shift keying.

In one embodiment, the method further comprises using a higher granularity of CSI quantities that have been changed from a last report based on a predefined threshold value.

In certain embodiments, the method further comprises reporting a sub-band CQI in place of a configured wide-band CQI.

In some embodiments, the method further comprises indicating to the network unit a procedure used for a CSI report reduction and a type of RE utilization.

In various embodiments, a demodulation reference signal (DMRS) is used for carrying signaling to the network unit.

In one embodiment, indication information is mapped to dedicated REs with a pre-defined modulation and coding scheme on pre-defined locations in a resource block (RB) based on a remote unit configuration or with an arbitrary location decided by the UE.

In certain embodiments, the method further comprises using DMRS and an explicit indication corresponding to REs to indicate a selected CSI reduction procedure, a RE utilization procedure, or a combination thereof.

In one embodiment, an apparatus comprises a network device. The apparatus further comprises: a transmitter that: transmits a first configuration to a user equipment (UE) to activate an update of a channel state information (CSI) report; and transmits a second configuration from the network device to perform a resource utilization update on resources from the update of the CSI report; and a receiver that receives an indication from the UE, wherein the indication indicates a type of CSI update and a type of resource utilization update.

In certain embodiments, the transmitter transmits, via radio resource control (RRC) signaling, a CSI report set configuration or a flag activating or deactivating of a resource element (RE) utilization procedure.

In some embodiments, the transmitter transmits, via RRC signaling from the network device, information indicated an updated mapping table, wherein the update of the CSI report, a RE utilization procedure, or a combination thereof is performed based on the updated mapping table.

In various embodiments, the receiver receives an indication indicating a procedure used for a CSI report reduction and a type of RE utilization.

In one embodiment, a demodulation reference signal (DMRS) is used for carrying signaling for the UE.

In one embodiment, a method of a network device comprises: transmitting a first configuration to a user equipment (UE) to activate an update of a channel state information (CSI) report; transmitting a second configuration from the network device to perform a resource utilization update on resources from the update of the CSI report; and receiving an indication from the UE, wherein the indication indicates a type of CSI update and a type of resource utilization update.

In certain embodiments, the method further comprises transmitting, via radio resource control (RRC) signaling, a CSI report set configuration or a flag activating or deactivating of a resource element (RE) utilization procedure.

In some embodiments, the method further comprises transmitting, via RRC signaling from the network device, information indicated an updated mapping table, wherein the update of the CSI report, a RE utilization procedure, or a combination thereof is performed based on the updated mapping table.

In various embodiments, the method further comprises receiving an indication indicating a procedure used for a CSI report reduction and a type of RE utilization.

In one embodiment, a demodulation reference signal (DMRS) is used for carrying signaling for the UE.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a first configuration from a network device to activate an update of a channel state information (CSI) report;
receive a second configuration from the network device to perform a resource utilization update on resources from the update of the CSI report;
perform the update of the CSI report;
perform an uplink (UL) transmission based on the resources updated from the resource utilization update; and
transmit an indication to the network device, wherein the indication indicates a type of CSI update and a type of resource utilization update.

2. The UE of claim 1, wherein the at least one processor is configured to cause the UE to receive, via radio resource control (RRC) signaling, a CSI report set configuration or a flag activating or deactivating of a resource element (RE) utilization procedure.

3. The UE of claim 1, wherein the at least one processor is configured to cause the UE to perform the update of the CSI report, a resource element (RE) utilization procedure, or a combination thereof based on a table.

4. The UE of claim 1, wherein the at least one processor is configured to cause the UE to receive, via radio resource control (RRC) signaling from the network device, information indicating an updated mapping table, wherein the update of the CSI report, a resource element (RE) utilization procedure, or a combination thereof is performed based on the updated mapping table.

5. The UE of claim 1, wherein the at least one processor is configured to cause the UE to apply resource element (RE) repetition, modifying a repetition code for hybrid automatic repeat request (HARQ) feedback, modifying a rank indication (RI), or a combination thereof.

6. The UE of claim 1, wherein the at least one processor is configured to cause the UE to modify a coding type of a physical uplink control channel (PUCCH) transmission in response to a number of bits being reduced from greater than or equal to 11 bits to less than 11 bits or modifying a modulation type from quadrature phase shift keying to Pi/2 binary phase shift keying.

7. The UE of claim 1, wherein the at least one processor is configured to cause the UE to use a higher granularity of CSI quantities that have been changed from a last report based on a threshold value.

8. The UE of claim 1, wherein the at least one processor is configured to cause the UE to indicate to the network device a procedure used for a CSI report reduction and a type of resource element (RE) utilization.

9. The UE of claim 8, wherein a demodulation reference signal (DMRS) is used for carrying signaling to the network device.

10. The UE of claim 8, wherein indication information is mapped to dedicated REs with a pre-defined modulation and coding scheme on locations in a resource block (RB) based on a remote unit configuration or with an arbitrary location decided by the UE.

11. The UE of claim 8, wherein the at least one processor is configured to cause the UE to use DMRS and an explicit indication corresponding to REs to indicate a selected CSI reduction procedure, a RE utilization procedure, or a combination thereof.

12. A method performed by a user equipment (UE), the method comprising:
receiving a first configuration from a network device to activate an update of a channel state information (CSI) report;
receiving a second configuration from the network device to perform a resource utilization update on resources from the update of the CSI report;
performing the update of the CSI report;
performing an uplink (UL) transmission based on the resources updated from the resource utilization update; and
transmitting an indication to the network device, wherein the indication indicates a type of CSI update and a type of resource utilization update.

13. An apparatus for performing a network function, the apparatus comprising:
at least one memory; and
at least one processor coupled with the at least one memory and configured to cause the apparatus to:
transmit a first configuration to a user equipment (UE) to activate an update of a channel state information (CSI) report; and
transmit a second configuration from a network device to perform a resource utilization update on resources from the update of the CSI report; and
receive an indication from the UE, wherein the indication indicates a type of CSI update and a type of resource utilization update.

14. The apparatus of claim 13, wherein the at least one processor is configured to cause the apparatus to transmit, via radio resource control (RRC) signaling, a CSI report set configuration or a flag activating or deactivating of a resource element (RE) utilization procedure.

15. The apparatus of claim 13, wherein the at least one processor is configured to cause the apparatus to transmit, via radio resource control (RRC) signaling from the network device, information indicated an updated mapping table, wherein the update of the CSI report, a resource element (RE) utilization procedure, or a combination thereof is performed based on the updated mapping table.

16. A processor for wireless communication, comprising:
at least one controller coupled with at least one memory and configured to cause the processor to:
receive a first configuration from a network device to activate an update of a channel state information (CSI) report;
receive a second configuration from the network device to perform a resource utilization update on resources from the update of the CSI report;
perform the update of the CSI report;
perform an uplink (UL) transmission based on the resources updated from the resource utilization update; and
transmit an indication to the network device, wherein the indication indicates a type of CSI update and a type of resource utilization update.

17. The processor of claim 16, wherein the at least one controller is configured to cause the processor to receive, via radio resource control (RRC) signaling, a CSI report set configuration or a flag activating or deactivating of a resource element (RE) utilization procedure.

18. The processor of claim 16, wherein the at least one controller is configured to cause the processor to perform the update of the CSI report, a resource element (RE) utilization procedure, or a combination thereof based on a table.

19. The processor of claim 16, wherein the at least one controller is configured to cause the processor to receive, via radio resource control (RRC) signaling from the network device, information indicating an updated mapping table, wherein the update of the CSI report, a resource element (RE) utilization procedure, or a combination thereof is performed based on the updated mapping table.

20. The processor of claim 16, wherein the at least one controller is configured to cause the processor to apply resource element (RE) repetition, modifying a repetition code for hybrid automatic repeat request (HARQ) feedback, modifying a rank indication (RI), or a combination thereof.
